(19) United States
(12) Patent Application Publication
(10) Pub. No.: US 2026/0098229 A1
(43) Pub. Date: Apr. 9, 2026

(54) CLEANING SOLUTION

(71) Applicant: KYOCERA DOCUMENT SOLUTIONS INC., OSAKA (JP)

(72) Inventor: MOTONOBU SUGIMOTO, OSAKA (JP)

(21) Appl. No.: 19/347,742

(22) Filed: Oct. 2, 2025

(30) Foreign Application Priority Data
Oct. 7, 2024 (JP) 2024-175973

(51) Int. Cl. C11D 1/90; C11D 3/20; C11D 3/37; C11D 3/43

(52) U.S. Cl. CPC C11D 1/90; C11D 3/2044; C11D 3/3765; C11D 3/43

(57) ABSTRACT

A cleaning solution includes: an organic solvent having a C log P value of −1.0 or less, an amphoteric surfactant having a betaine structure, a polycarboxylic acid polymer having an average molecular weight of 2000 or more and 50000 or less, and water. The content of the organic solvent is 10 parts by mass or more. The content of the polycarboxylic acid polymer is 0.1 part by mass or more and 1 part by mass or less, and the content of the water is 30 parts by mass or more. The percentage of the content of the amphoteric surfactant to the content of the organic solvent is 0.5% or more and 1.5% or less.

### CROSS-REFERENCE TO RELATED PATENT APPLICATION

This application claims the benefit of Japanese Priority Patent Application JP 2024-175973 filed Oct. 7, 2024, the entire contents of which are incorporated herein by reference.

### FIELD OF THE DISCLOSURE

The present disclosure relates to a cleaning solution.

### BACKGROUND OF THE DISCLOSURE

In the past, inks containing binder resins, which exhibit excellent fixability to recording media with low ink absorption (low absorption media), have been known. Such inks containing binder resins strongly adhere to a substrate upon drying. For this reason, in the case where the above ink adheres to a nozzle plate of an inkjet head and dries, it is difficult to remove the dried product of the ink.

Various cleaning solutions for removing the dried ink formed by drying on the nozzle plate or the like have been proposed. For example, Japanese Patent Application Laid-open No. 2011-194744 discloses a maintenance solution including alkane-1,2-diol monoalkyl ether having a C log P value of 0.6 or more and 1.0 or less, and Japanese Patent No. 6374740 discloses a cleaning solution including an amphoteric surfactant, a basic compound, and water, which does not include an aromatic hydrocarbon compound or a ketone compound as an organic solvent, the cleaning solution having a pH of 9 to 12, the amphoteric surfactant being at least one selected from the group consisting of dimethyllaurylamine oxide, lauryldimethylaminoacetic acid betaine, and 2-alkyl-N-carboxymethyl-N-hydroxyethylimidazolinium betaine, the content of the amphoteric surfactant being 0.1 to 3 mass % with respect to the total amount of the cleaning solution.

### SUMMARY OF THE DISCLOSURE

According to an embodiment of the present disclosure, there is provided a cleaning solution, including: an organic solvent having a C log P value of −1.0 or less; an amphoteric surfactant having a betaine structure; a polycarboxylic acid polymer having an average molecular weight of 2000 or more and 50000 or less; and water.

The content of the organic solvent is 10 parts by mass or more, the content of the polycarboxylic acid polymer is 0.1 part by mass or more and 1 part by mass or less, and the content of the water is 30 parts by mass or more.

The percentage of the content of the amphoteric surfactant to the content of the organic solvent is 0.5% or more and 1.5% or less.

### DETAILED DESCRIPTION OF THE EXEMPLARY EMBODIMENTS

The maintenance solution described in the above Background includes a highly hydrophobic solvent as described above, and thus has a possibility to corrode the materials forming the inkjet printer and the like, which posed a safety issue. Further, the cleaning solution described in the above Background includes one component as a cleaning component, leading to a problem of low cleaning performance against the inks containing binder resins described above.

In view of the circumstances as described above, it is an object of the present disclosure to provide a cleaning solution capable of safely and efficiently removing the dried product of ink containing a binder resin.

An embodiment of the present disclosure will be described below.

### Embodiment: Cleaning Solution

### Overall Configuration

A cleaning solution according to an embodiment of the present disclosure will be described below. The cleaning solution according to this embodiment includes an organic solvent, a cleaning component, and water.

First, a formation process of a dried ink that is a target of clearing by the cleaning solution according to this embodiment will be described.

In the case of forming an image using an inkjet recording device, an inkjet recording ink (hereinafter, referred to simply as “ink”) is ejected from the ejection surface of a recording head onto a recording medium. Specifically, the ink is ejected toward the recording medium from a plurality of ejection ports formed in the ejection surface. At this time, the ejected ink adheres to the ejection surface in some cases. When the ink adheres to the ejection surface, the adhered ink comes into contact with air and dries. In this way, the dried ink is formed.

Such a dried ink is particularly likely to be formed in the case where an ink having excellent fixability to recording media with low ink absorption (low absorption media) is used. This is because such an ink contains a relatively large amount of binder resin.

The dried ink can cause an ink ejection failure. This is because the dried ink blocks the ejection port depending on the position where the dried ink is formed. Specifically, when the dried ink blocks part or all of the ejection port, ink is difficult to eject and ink is ejected in a direction different from a desired ejection direction.

When an ink ejection failure occurs, the quality of the formed image deteriorates. For this reason, it is desired to remove the dried ink to prevent the ink ejection failure from occurring. However, with the existing cleaning solution, it has been difficult to remove particularly the dried product of ink containing a binder resin. Further, in the case where a cleaning solution includes a highly hydrophobic solvent, the cleaning solution has a possibility to corrode the materials forming the inkjet printer and the like, which posed a safety issue.

Meanwhile, the cleaning solution according to this embodiment includes: an organic solvent; an amphoteric surfactant and a polycarboxylic acid polymer as cleaning components, and water.

The organic solvent has a C log P value of −1.0 or less. The amphoteric surfactant has a betaine structure. The polycarboxylic acid polymer has an average molecular weight of 2000 or more and 50000 or less. The content of the organic solvent is 10 parts by mass or more, the content of the polycarboxylic acid polymer is 0.1 part by mass or more and 1 part by mass or less, and the content of the water is 30 parts by mass or more. Further, the percentage of the content of the amphoteric surfactant to the content of the organic solvent is 0.5% or more and 1.5% or less.

By causing a cleaning solution to include an organic solvent having a C log P value of −1.0 or less as an organic solvent, it is possible to ensure high cleaning performance and safety as follows. The organic solvent has low hydrophobicity because the C log P value is-1.0 or less, which makes the cleaning solution less likely to dry. This allows the decrease in cleaning performance due to the drying of the cleaning solution to be suppressed. Further, since the hydrophobicity is low, it is less likely to corrode the materials forming the inkjet printer and the like, which allows the safety to be enhanced. Therefore, by causing the cleaning solution to include the above organic solvent, the effect of improving safety can be achieved while ensuring high cleaning performance.

Further, by causing a cleaning solution to include the above amphoteric surfactant and the above polycarboxylic acid polymer as cleaning components, the cleaning solution becomes more easily penetrate into the dried ink. In order for the cleaning solution to remove the dried ink, the cleaning solution needs to penetrate into the dried ink to cause a chemical reaction with the dried ink, thereby dissolving or dispersing the dried ink. That is, the cleaning solution exhibits its cleaning effect by, for example, dissolving the dried ink. By including the above cleaning component, the cleaning solution according to this embodiment is capable of penetrating into the dried ink and exhibiting a high cleaning effect. Therefore, by causing a cleaning solution to include the above cleaning component, the effect of penetrating into a dried ink and enhancing the removability of the dried ink can be achieved.

Further, by setting the percentage of the content of the amphoteric surfactant to the content of the organic solvent to 0.5% or more and 1.5% or less, both of them are capable of exerting the above effects in a balanced manner and the synergistic effect of both of them allows higher removability of the dried ink to be provided.

The cleaning solution according to this embodiment is capable of easily penetrating into the dried ink by including the organic solvent and cleaning component described above. For this reason, the cleaning solution according to this embodiment swells and dissolves the dried ink. As a result, it is possible to easily remove the dried ink by a wipe operation using a rubber blade, or the like.

The cleaning solution according to this embodiment has high removability described above and is effective particularly for removing the dried product of ink having excellent fixability to low absorption media, or the like. Further, the cleaning solution according to this embodiment is less likely to corrode the materials forming the inkjet printer and the like, and is safer than the existing cleaning solutions. That is, according to the cleaning solution according to this embodiment, it is possible to safely and efficiently remove the dried product of ink that contains a large amount of binder resin and is difficult to dissolve or disperse.

As described above, the cleaning solution according to this embodiment is capable of suitably removing the dried ink. However, the cleaning solution according to this embodiment is capable of suitably removing not only the dried ink but also undried ink.

Next, respective components constituting the cleaning solution according to this embodiment will be described.

### (Organic Solvent)

The organic solvent included in the cleaning solution according to this embodiment has a C log P value of −1.0 or less. The C log P is a predicted value of an octanol/water partition coefficient log P (more specifically, 1-octanol/water partition coefficient log P) that is a numerical value indicating the hydrophilicity and hydrophobicity of a compound. The octanol/water partition coefficient log P is the logarithm of an octanol/water partition coefficient. The C log P is calculated using, for example, “ChemDraw” manufactured by PerkinElmer, inc. A larger C log P value indicates higher hydrophobicity of the compound.

Examples of the organic solvent included in the cleaning solution according to this embodiment include a glycol compound, a glycol ether compound, a lactam compound, a nitrogen-containing compound, an acetate compound, thiodiglycol, glycerin, and dimethylsulfoxide, which have a C log P value of −1.0 or less.

Examples of the glycol compound having a C log P value of −1.0 or less include 1,2-propanediol and 1,3-propanediol.

As the organic solvent, a glycol compound and glycerin are favorable, and 1,3-propanediol is more favorable.

The content of the organic solvent in the cleaning solution according to this embodiment is favorably 5 mass % or more and 70 mass % or less, more favorably 10 mass % or more and 65 mass % or less, with respect to the total mass of the cleaning solution.

### (Cleaning Component)

The cleaning component included in the cleaning solution according to this embodiment includes a surfactant and a polycarboxylic acid polymer.

### (Surfactant)

The surfactant in the cleaning solution according to this embodiment is an amphoteric surfactant having a betaine structure. The betaine refers to an intramolecular salt having a cationic structure (e.g., a quaternary ammonium ion structure) and an anionic structure (e.g., an anionic structure of an acid such as carboxylic acid) in one molecule. Examples of the amphoteric surfactant having a betaine structure include coconut oil fatty acid amidopropyl dimethyl acetate betaine, coconut oil fatty acid amidopropyl betaine, lauramidopropyl betaine, palm kernel fatty acid amidopropyl betaine, isostearic acid amidopropyl betaine, and linoleic acid amidopropyl betaine. As the amphoteric surfactant having a betaine structure, an amphoteric surfactant having a coconut oil fatty acid amidopropyl dimethyl acetate betaine structure is favorable. The amphoteric surfactant having a betaine structure has excellent performance in adhering to the surroundings of the dried ink to release the dried ink and excellent performance in dispersing the dried ink in the cleaning solution.

The content of the amphoteric surfactant having a betaine structure in the cleaning solution according to this embodiment is favorably 0.1 mass % or more and 5 mass % or less, more favorably 0.3 mass % or more and 1.5 mass % or less, particularly favorably 0.3 parts by mass or more and 1.0 part by mass or less, with respect to the total mass of the cleaning solution. Further, the percentage of the content of the amphoteric surfactant to the content of the organic solvent is favorably 0.5% or more and 1.5% or less.

Note that as the surfactant, only one type of surfactant may be used or two or more types of surfactants may be mixed and used. Further, the above surfactant and a different surfactant described below may be combined.

### (Other Surfactants)

The cleaning solution according to this embodiment may include a different surfactant. Examples of the different surfactant include a cationic surfactant, an anionic surfactant, a zwitterionic surfactant other than the above surfactants, and a nonionic surfactant. As the different surfactant, the nonionic surfactant is favorable.

The content of the different surfactant in the cleaning solution according to this embodiment is favorably 0.1 mass % or more and 5 mass % or less, more favorably 0.3 mass % or more and 5 mass % or less, with respect to the total mass of the cleaning solution.

Note that as the different surfactant, only one type of surfactant may be used or two or more types of surfactants may be mixed and used.

### (Polycarboxylic Acid Polymer)

The polycarboxylic acid polymer in the cleaning solution according to this embodiment is a polycarboxylic acid polymer having an average molecular weight of 2000 or more and 50000 or less. Examples of the polycarboxylic acid polymer include polyacrylic acid and its salt, polymaleic acid and its salt, an acrylic acid-maleic acid copolymer and its salt, an acrylic acid-sulfonic acid monomer copolymer and its salt, an acrylic acid-methacrylic acid copolymer and its salt.

The polycarboxylic acid polymer in the cleaning solution according to this embodiment has an average molecular weight of 2000 or more and 50000 or less as described above. The molecular weight is measured using for example, gel permeation chromatography. When the molecular weight of the polycarboxylic acid polymer is within this range, a cleaning solution including the polycarboxylic acid polymer easily penetrates into the dried ink, which is favorable from the viewpoint of the removability of the dried ink.

The content of the polycarboxylic acid polymer in the cleaning solution according to this embodiment is favorably 0.02 mass % or more and 1 mass % or less, more favorably 0.04 mass % or more and 1 mass % or less, particularly favorably 0.1 part by mass or more and 1 part by mass or less, with respect to the total mass of the cleaning solution.

### (Water)

Examples of the water included in the cleaning solution according to this embodiment include commercially available purified water and ion exchanged water. As the water, ion exchanged water is more favorable.

The content of the water is favorably 20 mass % or more and 99 mass % or less, more favorably 30 mass % or more and 99 mass % or less, with respect to the total mass of the cleaning solution. When the content of the water is in this range, for example, the viscosity of the cleaning solution including the water can be made suitable for removing the dried ink.

By including the organic solvent, cleaning component, and water described above, the cleaning solution according to this embodiment easily penetrates into the dried ink, allowing safety to be enhanced by reducing hydrophobicity while suppressing the decrease in cleaning performance due to drying of the cleaning solution. Therefore, the cleaning solution according to this embodiment is capable of safely and efficiently removing the dried product of ink that contains a large amount of binder resin and is difficult to dissolve or disperse.

### Others

The cleaning solution according to this embodiment may further include, as necessary, known additives (e.g., a solubility stabilizer, an anti-drying agent, an antioxidant, a viscosity adjustor, a pH adjuster, and an antifungal agent).

### (Physical Properties of Cleaning Solution)

Next, the physical properties of the cleaning solution according to this embodiment will be described.

### Static Surface Tension

The cleaning solution according to this embodiment has a static surface tension of less than 40 mN/m. Specifically, the static surface tension at 25° C. of the cleaning solution is favorably 20 mN/m or more and less than 40 mN/m, more favorably 22 mN/m or more and less than 30 mN/m. When the static surface tension of the cleaning solution is in this range, the wettability of the cleaning solution increases and the cleaning solution quickly penetrates into the gap between the ink and the nozzle plate, or the like, which is favorable from the viewpoint of the removability of the dried ink.

### Viscosity and pH

The viscosity of the cleaning solution according to this embodiment is not particularly limited, but is favorably 1 mPa·s or more and 10 mPa·s or less, more favorably 1 mPa·s or more and 8 mPa·s or less. Further, the pH of the cleaning solution according to this embodiment is not particularly limited, but is favorably 7 or more and 14 or less, more favorably 9 or more and 10 or less considering the balance between chemical damage to the inkjet head and cleaning performance.

### (Method of Removing Dried Ink)

The method of removing the dried ink using the cleaning solution according to this embodiment is not particularly limited. However, for example, the dried ink is removed as follows.

First, the cleaning solution according to this embodiment is supplied to the ejection surface of the recoding head to which the dried ink adheres. Examples of the method of supplying the cleaning solution to the ejection surface include supplying with a sponge or a sheet impregnated with the cleaning solution, ejecting the cleaning solution by an ink jet method, applying the cleaning solution using a roller, and spraying the cleaning solution. After that, a wipe operation is performed on the ejection surface using a wiping blade or the like. In this way, the dried ink adhering to the ejection surface can be easily removed.

Note that the cleaning solution according to this embodiment can also be used to remove the dried ink adhering to the member included in the inkjet recording device other than the recoding head.

### OTHER EMBODIMENTS

Although an embodiment of the present disclosure has been described above, it goes without saying that the present disclosure is not limited to only the above-mentioned embodiment and various modifications can be made.

### EXAMPLES AND COMPARATIVE EXAMPLES

Although Examples of the present disclosure will be described below, the present disclosure is not limited to these Examples.

### (Preparation of Cleaning Solution)

In each of Examples and Comparative Examples, materials shown in Table 1 and Table 2 were added to a beaker in the blending amount shown in Table 1 and Table 2. The mixture in the beaker was stirred at a rotational speed of 400 rpm for 30 minutes using a stirrer (“Three-One Motor BL-600” manufactured by Shinto Scientific Co., Ltd.) to prepare the cleaning solution according to each of Examples and Comparative Examples.

TABLE 1

| | | Example | | | | | | | | |
|---|---|---|---|---|---|---|---|---|---|---|
| | | 1 | 2 | 3 | 4 | 5 | 6 | 7 | 8 | 9 |
| Cleaning solution | | CL-1 | CL-2 | CL-3 | CL-4 | CL-5 | CL-6 | CL-7 | CL-8 | CL-9 |
| Organic | 1,2-propanediol | — | — | 60 | — | — | 10 | — | — | — |
| solvent | 1,3-propanediol | 30 | 60 | — | — | 10 | — | — | 30 | 30 |
| | Glycerin | — | — | — | 55 | — | — | 10 | — | — |
| | Triethylene | — | — | — | — | — | — | — | — | — |
| | glycol | | | | | | | | | |
| | monobutyl | | | | | | | | | |
| | ether | | | | | | | | | |
| | Diethylene | — | — | — | — | — | — | — | — | — |
| | glycol | | | | | | | | | |
| | monobutyl | | | | | | | | | |
| | ether | | | | | | | | | |
| Surfactant | AMOGEN CB-H | 0.3 | 0.6 | 0.6 | 0.55 | 0.1 | 0.1 | 0.1 | 0.45 | 0.15 |
| | OLFINE | — | — | — | — | — | — | — | — | — |
| | EXP4300 | | | | | | | | | |
| | SILFACE | 0.3 | 0.3 | 0.3 | 0.3 | 0.3 | 0.3 | 0.3 | 0.3 | 0.3 |
| | SAG503A | | | | | | | | | |
| Poly- | Aqualic DL-40 | 0.5 | 0.5 | 0.5 | 0.5 | 0.5 | 0.5 | 0.5 | 0.5 | 0.5 |
| carboxylic | Aqualic DL-453 | — | — | — | — | — | — | — | — | — |
| acid polymer | Aqualic DL-522 | — | — | — | — | — | — | — | — | — |
| | Aqualic TL-37 | — | — | — | — | — | — | — | — | — |
| Water | Ion ex- | 68.9 | 38.6 | 38.5 | 43.65 | 89.1 | 89.1 | 89.1 | 68.75 | 69.05 |
| | changed water | | | | | | | | | |
| Surfactant/organic | | 1 | 1 | 1 | 1 | 1 | 1 | 1 | 1.5 | 0.5 |
| solvent percentage (%) | | | | | | | | | | |
| Cleaning | Surface | 23 | 23 | 23 | 23 | 23 | 23 | 23 | 23 | 23 |
| solution | tension (mN/m) | | | | | | | | | |
| physical | Viscosity | 2.4 | 7.8 | 7.8 | 7.7 | 1.3 | 1.3 | 1.3 | 2.4 | 2.4 |
| properties | (mPa · s) | | | | | | | | | |

| | | | | | | | | | |
|---|---|---|---|---|---|---|---|---|---|
| Ink | I-1 | I-1 | I-1 | I-1 | I-1 | I-1 | I-1 | I-1 | I-1 |
| Evaluation result | 100% | 90% | 80% | 80% | 100% | 95% | 85% | 85% | 85% |

| | | Example | | | | | | |
|---|---|---|---|---|---|---|---|---|
| | | 10 | 11 | 12 | 13 | 14 | 35 | 16 |
| Cleaning solution | | CL-10 | CL-11 | CL-12 | CL-13 | CL-14 | CL-15 | CL-1 |
| Organic | 1,2-propanediol | — | — | — | — | — | — | — |
| solvent | 1,3-propanediol | 30 | 30 | 30 | 30 | 30 | 30 | 30 |
| | Glycerin | — | — | — | — | — | — | — |
| | Triethylene | — | — | — | — | — | — | — |
| | glycol | | | | | | | |
| | monobutyl | | | | | | | |
| | ether | | | | | | | |
| | Diethylene | — | — | — | — | — | — | — |
| | glycol | | | | | | | |
| | monobutyl | | | | | | | |
| | ether | | | | | | | |
| Surfactant | AMOGEN CB-H | 0.3 | 0.3 | 0.3 | 0.3 | 0.3 | 0.3 | 0.3 |
| | OLFINE | — | — | — | — | 0.5 | — | — |
| | EXP4300 | | | | | | | |
| | SILFACE | 0.3 | 0.3 | 0.3 | 0.3 | — | — | 0.3 |
| | SAG503A | | | | | | | |
| Poly- | Aqualic DL-40 | 0.1 | 1 | — | — | 0.5 | 0.5 | 0.5 |
| carboxylic | Aqualic DL-453 | — | — | 0.57 | — | — | — | — |
| acid polymer | Aqualic DL-522 | — | — | — | — | — | — | — |
| | Aqualic TL-37 | — | — | — | 0.54 | — | — | — |
| Water | Ion ex- | 69.3 | 68.4 | 68.83 | 68.86 | 68.7 | 69.2 | 88.9 |
| | changed water | | | | | | | |
| Surfactant/organic | | 1 | 1 | 1 | 1 | 1 | 1 | 1 |
| solvent percentage (%) | | | | | | | | |
| Cleaning | Surface | 23 | 23 | 23 | 23 | 27 | 36 | 23 |
| solution | tension (mN/m) | | | | | | | |
| physical | Viscosity | 2.3 | 2.5 | 3.1 | 2.4 | 2.4 | 2.5 | 2.4 |
| properties | (mPa · s) | | | | | | | |

| | | | | | | | |
|---|---|---|---|---|---|---|---|
| Ink | I-1 | I-1 | I-1 | I-1 | I-1 | I-1 | I-2 |
| Evaluation result | 80% | 100% | 95% | 100% | 95% | 95% | 100% |

| | | Comparative Example | | | | | | | |
|---|---|---|---|---|---|---|---|---|---|
| | | 1 | 2 | 3 | 4 | 5 | 6 | 7 | 8 |
| Cleaning solution | | CL-16 | CL-17 | CL-18 | CL-19 | CL-20 | CL-21 | CL-22 | CL-23 |
| Organic | 1,2-propanediol | — | — | — | — | — | — | — | — |
| solvent | 1,3-propanediol | 30 | 30 | — | — | 30 | 30 | 30 | 30 |
| | Glycerin | — | — | — | — | — | — | — | — |
| | Triethylene | — | — | 30 | — | — | — | — | — |
| | glycol | | | | | | | | |
| | monobutyl | | | | | | | | |
| | ether | | | | | | | | |
| | Diethylene | — | — | — | 30 | — | — | — | — |
| | glycol | | | | | | | | |
| | monobutyl | | | | | | | | |
| | ether | | | | | | | | |
| Surfactant | AMOGEN CB-H | 0.3 | — | 0.5 | 0.3 | 0.1 | 0.5 | 0.3 | 0.3 |
| | OLFINE | — | — | — | — | — | — | — | — |
| | EXP4300 | | | | | | | | |
| | SILFACE | 0.3 | 0.3 | 0.3 | 0.3 | 0.3 | 0.3 | 0.3 | 0.3 |
| | SAG503A | | | | | | | | |
| Polycarboxylic | Aqualic DL-40 | — | 0.5 | 0.5 | 0.5 | 0.5 | 0.5 | 0.05 | 1.5 |
| acid polymer | Aqualic DL-453 | — | — | — | — | — | — | — | — |
| | Aqualic DL-522 | — | — | — | — | — | — | — | — |
| | Aqualic TL-37 | — | — | — | — | — | — | — | — |
| Water | Ion ex- | 69.4 | 69.2 | 68.9 | 68.9 | 69.1 | 68.7 | 59.35 | 67.9 |
| | changed water | | | | | | | | |
| Surfactant/organic | | 1 | — | 1 | 1 | 0.33 | 1.67 | 1 | 1 |
| solvent percentage (%) | | | | | | | | | |
| Cleaning | Surface | 23 | 23 | 23 | 23 | 23 | 23 | 23 | 23 |
| solution | tension (mN/m) | | | | | | | | |
| physical | Viscosity | 2.9 | 2.4 | 3.1 | 2.9 | 2.4 | 2.4 | 2.3 | 2.6 |
| properties | (mPa · s) | | | | | | | | |

| | | | | | | | | |
|---|---|---|---|---|---|---|---|---|
| Ink | I-1 | I-2 | I-1 | I-2 | I-1 | I-1 | I-1 | I-1 |
| Evaluation result | 20% | 10% | 25% | 30% | 75% | 75% | 55% | 70% |

| | | Comparative Example | | | | | | |
|---|---|---|---|---|---|---|---|---|
| | | 9 | 10 | 11 | 12 | 13 | 14 | 15 |
| Cleaning solution | | CL-24 | CL-25 | CL-26 | CL-27 | CL-28 | CL-29 | CL-30 |
| Organic | 1,2-propanediol | — | 5 | — | — | 70 | — | — |
| solvent | 1,3-propanediol | 5 | — | — | 70 | — | — | — |
| | Glycerin | — | — | 5 | — | — | 70 | — |
| | Triethylene | — | — | — | — | — | — | — |
| | glycol | | | | | | | |
| | monobutyl | | | | | | | |
| | ether | | | | | | | |
| | Diethylene | — | — | — | — | — | — | — |
| | glycol | | | | | | | |
| | monobutyl | | | | | | | |
| | ether | | | | | | | |
| Surfactant | AMOGEN CB-H | 0.05 | 0.05 | 0.05 | 0.7 | 0.7 | 0.7 | 0.3 |
| | OLFINE | — | — | — | — | — | — | — |
| | EXP4300 | | | | | | | |
| | SILFACE | 8.3 | 0.3 | 0.3 | 0.3 | 0.3 | 0.3 | 0.3 |
| | SAG503A | | | | | | | |
| Polycarboxylic | Aqualic DL-40 | 0.5 | 0.5 | 0.5 | 0.5 | 0.5 | 0.5 | — |
| acid polymer | Aqualic DL-453 | — | — | — | — | — | — | — |
| | Aqualic DL-522 | — | — | — | — | — | — | 0.67 |
| | Aqualic TL-37 | — | — | — | — | — | — | — |
| Water | Ion ex- | 94.15 | 94.15 | 94.15 | 28.5 | 28.5 | 28.5 | 68.73 |
| | changed water | | | | | | | |
| Surfactant/organic | | 1 | 1 | 1 | 1 | 1 | 1 | 1 |
| solvent percentage (%) | | | | | | | | |
| Cleaning | Surface | 23 | 23 | 23 | 23 | 23 | 23 | 23 |
| solution | tension (mN/m) | | | | | | | |
| physical | Viscosity | 1.1 | 1.1 | 1.1 | 10.5 | 11.0 | 19.2 | 5.7 |
| properties | (mPa · s) | | | | | | | |

| | | | | | | | |
|---|---|---|---|---|---|---|---|
| Ink | I-1 | I-1 | I-1 | I-1 | I-1 | I-1 | I-1 |
| Evaluation result | 70% | 60% | 55% | 30% | 20% | 0% | 75% |

As shown in Table 1, each of the cleaning solutions according to Examples 1 to 16 includes AMOGEN CB-H as a surfactant. AMOGEN CB-His an amphoteric surfactant having a coconut oil fatty acid amidopropyl dimethyl acetate betaine structure. Note that SILFACE SAG503A and OLFINE EXP4300 are each a surfactant having no coconut oil fatty acid amidopropyl dimethyl acetate betaine structure.

Further, the cleaning solutions according to Examples 1 to 16 include 1,2-propanediol, 1,3-propanediol, or glycerin as an organic solvent, and Aqualic DL-40, Aqualic DL-453, or Aqualic TL-37 as a polycarboxylic acid polymer, as shown in Table 1. Aqualic DL-40 has an average molecular weight of 3500, Aqualic DL-453 has an average molecular weight of 50000, and Aqualic TL-37 has an average molecular weight of 5000, which are within the range of 2000 or more and 50000 or less. Note that Aqualic DL-522 has an average molecular weight of 170000, which is outside the range of 2000 or more and 50000 or less. Further, in all Examples, the content of the organic solvent is 10 parts by mass or more, the content of the polycarboxylic acid polymer is 0.1 part by mass or more and 1 part by mass or less, the content of water is 30 parts by mass or more, and the percentage of the content of the amphoteric surfactant to the content of the organic solvent is 0.5% or more and 1.5% or less.

As shown in Table 2, Comparative Example 1 is different from Example 1 in that Aqualic DL-40 is not included. Note that the mass % of ion exchanged water has been increased by the mass % (0.5 mass %) of Aqualic DL-40 in Example 1.

Comparative Example 2 is different from Example 1 in that AMOGEN CB-H is not included. Note that the mass % of ion exchanged water has been increased by the mass % (0.3 mass %) of AMOGEN CB-H in Example 1.

Comparative Example 3 is different from Example 1 in that it includes triethylene glycol monobutyl ether as an organic solvent instead of 1,3-propanediol.

Comparative Example 4 is different from Example 1 in that it includes diethylene glycol monobutyl ether as an organic solvent instead of 1,3-propanediol.

In Comparative Example 5, the mass % of AMOGEN CB-H is lower than that in Example 1 and the mass % of ion exchanged water is higher than that in Example 1 by that amount (0.2 mass %). As a result, the percentage of the content of the amphoteric surfactant to the content of the organic solvent is 0.33% (rounded to two decimal places), which is outside the range of 0.5% or more and 1.5% or less.

In Comparative Example 6, the mass % of AMOGEN CB-H is higher than that in Example 1 and the mass % of ion exchanged water is lower than that in Example 1 by that amount (0.2 mass %). As a result, the percentage of the content of the amphoteric surfactant to the content of the organic solvent is 1.67% (rounded to two decimal places), which is outside the range of 0.5% or more and 1.5% or less.

In Comparative Example 7, the mass % of Aqualic DL-40 is lower than that in Example 1 and the mass % of ion exchanged water is higher than that in Example 1 by that amount (0.45 mass %). As a result, the content of the polycarboxylic acid polymer is 0.05 parts by mass, which is outside the range of 0.1 part by mass or more and 1 part by mass or less.

In Comparative Example 8, the mass % of Aqualic DL-40 is higher than that in Example 1 and the mass % of ion exchanged water is higher than that in Example 1 by that amount (1.0 mass %). As a result, the content of the polycarboxylic acid polymer is 1.5 parts by mass, which is outside the range of 0.1 part by mass or more and 1 part by mass or less.

In Comparative Example 9, the mass % of 1,3-propanediol and the mass % of AMOGEN CB-H are lower than those in Example 1 and the mass % of ion exchanged water is higher than that in Example 1 by those amounts (25+0.25=25.25 mass %). As a result, the content of the organic solvent is 5 parts by mass, which is outside the range of 10 parts by mass or more.

In Comparative Example 10, 1,2-propanediol is used as an organic solvent instead of 1,3-propanediol, the mass % of the organic solvent and the mass % of AMOGEN CB-H are lower than those in Example 1, and the mass % of ion exchanged water is higher than that in Example 1 by those amounts (25+0.25=25.25 mass %). As a result, the content of the organic solvent is 5 parts by mass, which is outside the range of 10 parts by mass or more.

In Comparative Example 11, glycerin is used as an organic solvent instead of 1,3-propanediol, the mass % of the organic solvent and the mass % of AMOGEN CB-H are lower than those in Example 1, and the mass % of ion exchanged water is higher than that in Example 1 by those amounts (25+0.25=25.25 mass %). As a result, the content of the organic solvent is 5 parts by mass, which is outside the range of 10 parts by mass or more.

In Comparative Example 12, the mass % of 1,3-propanediol and the mass % of AMOGEN CB-H are higher than those in Example 1 and the mass % of ion exchanged water is lower than that in Example 1 by those amounts (40+0.4=40.4 mass %). As a result, the content of water is 28.5 parts by mass, which is outside the range of 30 parts by mass or more.

In Comparative Example 13, 1,2-propanediol is used as an organic solvent instead of 1,3-propanediol, the mass % of the organic solvent and the mass % of AMOGEN CB-H are higher than those in Example 1, and the mass % of ion exchanged water is lower than that in Example 1 by those amounts (40+0.4=40.4 mass %). As a result, the content of water is 28.5 parts by mass, which is outside the range of 30 parts by mass or more.

In Comparative Example 14, glycerin is used as an organic solvent instead of 1,3-propanediol, the mass % of the organic solvent and the mass % of AMOGEN CB-H are higher than those in Example 1, and the mass % of ion exchanged water is lower than that in Example 1 by those amounts (40+0.4=40.4 mass %). As a result, the content of water is 28.5 parts by mass, which is outside the range of 30 parts by mass or more.

In Comparative Example 15, Aqualic DL-522 is used as a polycarboxylic acid polymer instead of Aqualic DL-40, the mass % of the polycarboxylic acid polymer is higher than that in Example 1, and the mass % of ion exchanged water is lower than that in Example 1 by that amount (0.17 mass %).

### (Preparation of Dried Ink)

7 parts by mass of a Bk dispersion, 5 parts by mass of a urethane binder resin, 0.5 parts by mass of an acetylene glycol surfactant, 10 parts by mass of a glycol ether, 3 parts by mass of a polyhydric alcohol, and 74.5 parts by mass of water were added to a beaker. The mixture in the beaker was stirred using a stirrer (“Three-One Motor BL-600” manufactured by Shinto Scientific Co., Ltd.) to obtain an ink (I-1). Further, similarly, 7 parts by mass of a Bk dispersion, 5 parts by mass of a styrene acrylic binder resin, 0.5 parts by mass of an acetylene glycol surfactant, 10 parts by mass of a glycol ether, 3 parts by mass of a polyhydric alcohol, and 74.5 parts by mass of water were added to a beaker, and the mixture in the beaker was mixed using a stirrer to obtain an ink (I-2). Using these inks (I-1) and (I-2), a plurality of ink droplets having a diameter of 20 μm was adhered to the nozzle plate of an inkjet head KJ4B-1200 manufactured by KYOCERA Document Solutions Inc. The adhered ink droplets were dried at a temperature of 30° C. for 72 hours to prepare a dried ink.

### (Method of Evaluating Ink Removability of Cleaning Solution)

In each of Examples and Comparative Examples, 0.1 ml of the cleaning solution was added dropwise onto a region of the thin stainless steel plate in the inkjet head where no ink droplet is adhered, using a pipettor. A wipe operation was performed twice at 20 second intervals on the above inkjet head using a rubber blade. The line pressure was constant at 10 N/m and the wiping speed was constant at 20 mm/s.

The ink removability of each cleaning solution was evaluated on the basis of the removal ratio of the ink droplet. The removal ratio was defined as the ratio of the number of ink droplets removed by the wipe operation to the number of the formed ink droplets, in the portion where the rubber blade comes into contact during the wipe operation.

### (Measurement of Static Surface Tension)

The static surface tension of each cleaning solution was measured using a surface tensiometer (“automatic surface tensiometer DY-300” manufactured by Kyowa Interface Science Co., Ltd.) in accordance with the Wilhelmy method (plate method). In all of Examples 1 to 16, the static surface tension at 25° C. was 23 or more and 36, which was within the range of 20 mN/m or more and less than 40 mN/m.

### (Calculation of C Log P Value)

The C log P value of the used organic solvent was calculated using “ChemDraw” manufactured by PerkinElmer, inc. The calculation results of the C log P value are as follows.

TABLE 3

| Organic solvent | ClogP |
|---|---|
| 1,2-propanediol | −1.06 |
| 1,3-propanediol | −1.04 |
| Glycerin | −1.54 |
| Triethylene glycol monobutyl ether | 0.49 |
| Diethylene glycol monobutyl ether | 0.67 |

As shown in Table 1 and Table 3, the organic solvent included in each of the cleaning solutions according to Example 1 to Example 16 had a C log P value of −1.0 or less.

### Evaluation of Examples and Comparative Examples

As shown in Table 1, all of the cleaning solutions according to Example 1 to Example 16 exhibited a high removal ratio of 80% or more. This is presumably because including an appropriate organic solvent, an appropriate cleaning component, and water in appropriate amounts allows higher removability of the dried ink to be exhibited by the synergistic effect thereof.

As shown in Table 2, the cleaning solution according to Comparative Example 1 had a low removal ratio, i.e., 20%. This is presumably because it does not include a polycarboxylic acid polymer having an average molecular weight of 2000 or more and 50000 or less, resulting in an insufficient effect of penetrating into the dried ink to increase the removability of the dried ink.

As shown in Table 2, the cleaning solution according to Comparative Example 2 had a low removal ratio, i.e., 10%. This is presumably because it does not include an amphoteric surfactant having a betaine structure, resulting in the wettability kept high, and it cannot penetrate into the gap between the dried ink and the nozzle plate or the like, resulting in insufficient removability of the dried ink.

As shown in Table 2, the cleaning solution according to Comparative Example 3 had a low removal ratio, i.e., 25%. This is presumably because it does not include an organic solvent having a C log P value of −1.0 or less, resulting in the cleaning component being absorbed by the organic solvent and insufficient removability of the dried ink.

As shown in Table 2, the cleaning solution according to Comparative Example 4 had a low removal ratio, i.e., 30%. This is presumably because it does not include an organic solvent having a C log P value of −1.0 or less, resulting in the cleaning component being absorbed by the organic solvent and insufficient removability of the dried ink.

As shown in Table 2, the cleaning solution according to Comparative Example 5 had a slightly low removal ratio, i.e., 75%. This is presumably because the percentage of the content of the amphoteric surfactant having a betaine structure to the content of the organic solvent having a C log P value of −1.0 or less is outside the range of 0.5% or more and 1.5% or less, so that both of them could not exert the above effects in a balanced manner and the synergistic effect of both of them did not allow higher removability of the dried ink to be achieved.

As shown in Table 2, the cleaning solution according to Comparative Example 6 had a slightly low removal ratio, i.e., 75%. This is presumably because the percentage of the content of the amphoteric surfactant having a betaine structure to the content of the organic solvent having a C log P value of −1.0 or less is outside the range of 0.5% or more and 1.5% or less, so that both of them could not exert the above effects in a balanced manner and the synergistic effect of both of them did not allow higher removability of the dried ink to be achieved.

As shown in Table 2, the cleaning solution according to Comparative Example 7 had a slightly low removal ratio, i.e., 65%. This is presumably because the content of the polycarboxylic acid polymer having an average molecular weight of 2000 or more and 50000 or less is outside the range of 0.1 part by mass or more and 1 part by mass or less, resulting in an insufficient effect of penetrating into the dried ink to increase the removability of the dried ink.

As shown in Table 2, the cleaning solution according to Comparative Example 8 had a slightly low removal ratio, i.e., 70%. This is presumably because the content of the polycarboxylic acid polymer having an average molecular weight of 2000 or more and 50000 or less is outside the range of 0.1 part by mass or more and 1 part by mass or less, resulting in an insufficient effect of penetrating into the dried ink to increase the removability of the dried ink.

As shown in Table 2, the cleaning solution according to Comparative Example 9 had a slightly low removal ratio, i.e., 70%. This is presumably because the content of the organic solvent having a C log P value of −1.0 or less is outside the range of 10 parts by mass or more, making it impossible to suppress the decrease in cleaning performance due to drying of the cleaning solution.

As shown in Table 2, the cleaning solution according to Comparative Example 10 had a slightly low removal ratio, i.e., 60%. This is presumably because the content of the organic solvent having a C log P value of −1.0 or less is outside the range of 10 parts by mass or more, making it impossible to suppress the decrease in cleaning performance due to drying of the cleaning solution.

As shown in Table 2, the cleaning solution according to Comparative Example 11 had a slightly low removal ratio, i.e., 55%. This is presumably because the content of the organic solvent having a C log P value of −1.0 or less is outside the range of 10 parts by mass or more, making it impossible to suppress the decrease in cleaning performance due to drying of the cleaning solution.

As shown in Table 2, the cleaning solution according to Comparative Example 12 had a low removal ratio, i.e., 30%. This is presumably because the content of water is outside the range of 30 parts by mass or more, resulting in high viscosity of the cleaning solution, and the cleaning solution could not sufficiently penetrate into the dried ink, resulting in insufficient removability of the dried ink.

As shown in Table 2, the cleaning solution according to Comparative Example 13 had a low removal ratio, i.e., 20%. This is presumably because the content of water is outside the range of 30 parts by mass or more, resulting in high viscosity of the cleaning solution, and the cleaning solution could not sufficiently penetrate into the dried ink, resulting in insufficient removability of the dried ink.

As shown in Table 2, the cleaning solution according to Comparative Example 14 had a low removal ratio, i.e., 0%. This is presumably because the content of water is outside the range of 30 parts by mass or more, resulting in high viscosity of the cleaning solution, and the cleaning solution could not sufficiently penetrate into the dried ink, resulting in insufficient removability of the dried ink.

As shown in Table 2, the cleaning solution according to Comparative Example 15 had a slightly low removal ratio, i.e., 75%. This is presumably because it does not include a polycarboxylic acid polymer having an average molecular weight of 2000 or more and 50000 or less, resulting in an insufficient effect of penetrating into the dried ink to increase the removability of the dried ink.

It should be understood by those skilled in the art that various modifications, combinations, sub-combinations and alterations may occur depending on design requirements and other factors insofar as they are within the scope of the appended claims or the equivalents thereof.

What is claimed is:

1. A cleaning solution, comprising:
an organic solvent having a C log P value of −1.0 or less;
an amphoteric surfactant having a betaine structure;
a polycarboxylic acid polymer having an average molecular weight of 2000 or more and 50000 or less; and
water,
a content of the organic solvent being 10 parts by mass or more, a content of the polycarboxylic acid polymer being 0.1 part by mass or more and 1 part by mass or less, a content of the water being 30 parts by mass or more,
a percentage of the content of the amphoteric surfactant to the content of the organic solvent being 0.5% or more and 1.5% or less.

2. The cleaning solution according to claim 1, wherein the cleaning solution has viscosity at 25° C. of 8.0 mPa·s or less.

3. The cleaning solution according to claim 1, wherein the cleaning solution has a static surface tension of 20 mN/m or more and less than 40 mN/m.

4. The cleaning solution according to claim 1, wherein
the organic solvent is selected from the group consisting of 1,2-propanediol, 1,3-propanediol, and glycerin.

5. The cleaning solution according to claim 4, wherein
the organic solvent is 1,3-propanediol.

6. The cleaning solution according to claim 1, wherein
the amphoteric surfactant is an amphoteric surfactant having a coconut oil fatty acid amidopropyl dimethyl acetate betaine structure.
